(19) United States
(12) Patent Application Publication
(10) Pub. No.: US 2009/0232978 A1
(43) Pub. Date: Sep. 17, 2009

(54) Process for Producing Optical Article

(75) Inventors: Keiichi SUZUKI, Okaya-shi (JP); Hiroyuki SEKI, Matsumoto-shi (JP); Yusuke KUTSUKAKE, Nagano-ken (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/402,003

(22) Filed: Mar. 11, 2009

(30) Foreign Application Priority Data
Mar. 17, 2008 (JP) 2008-067210
Dec. 15, 2008 (JP) 2008-318003

(51) Int. Cl. B05D 5/06

(52) U.S. Cl. 427/162

(57) ABSTRACT

A process for producing an optical article includes subjecting a work in which an antireflection layer is formed on an optical substrate directly or via another layer interposed therebetween and an antifouling layer is formed on a surface of the antireflection layer to an acid treatment by dipping it in an acidic liquid; rinsing the work subjected to the acid treatment; and annealing the rinsed work.

### BACKGROUND

1. Technical Field

The present invention relates to a process for producing an optical article having an antireflection layer and an antifouling layer provided on an optical substrate of such as glass or plastic.

2. Related Art

Optical articles having an antireflection layer formed on an optical substrate directly or via another layer interposed therebetween and an antifouling layer formed on a surface of the antireflection layer are known. Further, JP-A-2007-310053 discloses a coating composition for forming an organic antireflection layer and an antifouling layer provided on the organic antireflection layer. The coating composition for forming the organic antireflection layer contains at least a fluorine-containing silane compound, silica fine particles having a hollow interior, and a metal complex salt having aluminum as a central metal. The coating composition for forming the antifouling layer contains a fluorine-containing silane compound.

A chemical bond such as a siloxane bond (—Si—O—Si—) is formed between an antireflection layer and an antifouling layer, and this is one of the factors for fixing the antifouling layer on a surface of the antireflection layer. Further, the antifouling layer is formed as a layer through a condensation reaction between molecules forming the layer.

However, when the reactivity between the antireflection layer and the antifouling layer is low, the antifouling layer is not sufficiently fixed on the surface of the antireflection layer and it may sometimes be difficult to obtain sufficient durability. Further, when the reactivity between molecules forming the antifouling layer is low, it may sometimes be difficult to obtain sufficient durability. Therefore, a process for producing an optical article capable of forming an antifouling layer having good durability even when the reactivity between the antireflection layer and the antifouling layer or the reactivity between molecules forming the antifouling layer is low has been demanded.

### SUMMARY

One aspect of the invention is a process for producing an optical article which includes:
subjecting a work in which an antireflection layer is formed on an optical substrate directly or via another layer interposed therebetween and an antifouling layer is formed on a surface of the antireflection layer to an acid treatment by dipping it in an acidic liquid;
rinsing the work subjected to the acid treatment; and
annealing the rinsed work.

By subjecting a work in which an antireflection layer and an antifouling layer are formed to an acid treatment through dipping of the work in an acidic liquid, a hydroxy group (for example, —Si—OH) can be formed in molecules forming a surface of the antireflection layer and the antifouling layer. Due to this, a reaction between the antireflection layer and the antifouling layer is accelerated. That is, the formation of a chemical bond (such as —Si—O—Si— (a siloxane bond)) between the antireflection layer and the antifouling layer is accelerated, and the antifouling layer is favorably fixed on the surface of the antireflection layer. Further, in the antifouling layer, a condensation reaction (dehydration condensation reaction) of molecules forming the antifouling layer is accelerated, and the antifouling layer having good durability is formed.

According to this production process, the reaction between the antireflection layer and the antifouling layer is accelerated, and also the condensation reaction between molecules forming the antifouling layer is accelerated. Therefore, the antifouling layer having good durability can be formed on the surface of the antireflection layer. Accordingly, an optical article having high durability such as a spectacle lens can be produced.

The acid treatment is preferably performed after forming the antifouling layer. It is also conceivable that the acid treatment is performed after forming the antireflection layer or after annealing. However, a trouble as described below may be caused, therefore it is not so favorable. That is, when the acid treatment is performed after forming the antireflection layer, water marks are left on the surface and cannot be removed in some cases. In the case where the acid treatment is performed after annealing, the acid treatment is performed in a state where the bond formation between the antireflection layer and the antifouling layer, and the bond formation between molecules forming the antifouling layer are proceeding to a certain extent, therefore, these bonds may be cleaved instead.

A typical example of the antireflection layer is an organic antireflection layer formed from a composition containing an organosilicon compound. The antireflection layer may be an inorganic single layered antireflection layer or an inorganic multilayered antireflection layer formed by laminating an inorganic high refractive index layer and an inorganic low refractive index layer in a plurality of layers.

In the case of an inorganic multilayered antireflection layer, a low refractive index layer is laminated as an uppermost layer. The low refractive index layer is typically formed from silicon oxide such as SiO₂ or SiOₓ. Therefore, in the case of an inorganic antireflection layer, the content of silicon oxide in the surface is relatively high and the reactivity thereof with the antifouling layer is high.

Meanwhile, in the case of an organic antireflection layer, the content of silicon oxide in the surface is relatively low in most cases, and therefore as compared with an inorganic multilayered antireflection layer, the reactivity thereof with the antifouling layer is often low. Further, when fluorine is present in the interface between the antireflection layer and the antifouling layer, the reactivity between the antireflection layer and the antifouling layer may further be decreased. As described above, it tends to be difficult to sufficiently form a siloxane bond (—Si—O—Si—) on the surface of the organic antireflection layer.

According to this production process, the reaction between the antireflection layer and the antifouling layer can be accelerated, and therefore, the durability can be improved even when an optical article having an inorganic antireflection layer is produced. In particular, this production process is suitable for producing an optical article having an organic antireflection layer with a low reactivity.

The acidic liquid to be used in the acid treatment in this production process preferably contains any of hydrochloric acid, acetic acid, sulfuric acid, hydrofluoric acid, nitric acid, formic acid, carbonic acid, sulfurous acid, hypochlorous acid, and oxalic acid, and more preferably contains hydrochloric acid.

When the acidic liquid is a 1 N aqueous solution of hydrochloric acid, a dipping time in the acid treatment is preferably from 1 to 60 minutes. When the dipping time is less than 1 minute, an effect of accelerating the reaction between the antireflection layer and the antifouling layer and the condensation reaction between molecules forming the antifouling layer is low. When the dipping time exceeds 60 minutes, in the antireflection layer, the bond between molecules forming the antireflection layer may be cleaved, or the bond formed between the antireflection layer and the antifouling layer may be cleaved. More preferably, the dipping time in the acid treatment is from 5 to 15 minutes.

That is, the time t for dipping the work in the acidic liquid in the acid treatment is preferably a time defined by the following equation.

t=k/(N·α) (A)

In the equation (A), N represents a normality; k represents a constant; and α represents a degree of ionization. The degree of ionization α in the case where the acidic liquid is strongly acidic is about 1, and in the case where the acidic liquid is weakly acidic is between about 0.1 and about 0.01. The constant k preferably ranges from 1 to 60 (dipping time t (min)×normality (N)×degree of ionization α), more preferably ranges from 5 to 15, and most preferably is 10. That is, it is preferred that the acid treatment is performed such that the product of the dipping time t, the normality of the acidic liquid N, and the degree of ionization α falls within a predetermined range (constant k).

The annealing is performed for accelerating the reaction between the antireflection layer and the antifouling layer, and the condensation reaction between molecules forming the antifouling layer. One example of the conditions for the annealing is at a temperature of 90° C. and a relative humidity of 60%.

### BRIEF DESCRIPTION OF THE DRAWINGS

The invention will be described with reference to the accompanying drawings, wherein like numbers reference like elements.

FIG. 1 is a table summarizing the results of steel wool rubbing test for optical articles obtained in Examples 1 to 8 and Comparative examples 1 to 3.

FIG. 2 is a graph schematically showing a relationship between a dipping time in an acid treatment and durability of an optical article.

### DESCRIPTION OF EXEMPLARY EMBODIMENTS

One example of an optical article is a spectacle lens. When the spectacle lens is produced, a primer layer is formed on a surface of an optical substrate, and also a hard coat layer is formed on a surface of this primer layer, and further, an antireflection layer and an antifouling layer are formed thereon. The hard coat layer may be formed without forming the primer layer. In other optical articles, an antireflection layer and an antifouling layer are directly formed on a surface of an optical substrate.

As described above, the antireflection layer may be either inorganic or organic. The inorganic single layered or multilayered antireflection layer can be applied by, for example, the so-called PVD method such as ion plating, vacuum deposition, or sputtering. As one example of the inorganic antireflection layer, one obtained by laminating a low refractive index inorganic layer having a refractive index lower than that of an optical substrate or a layer formed on the optical substrate (such as a hard coat layer), etc. and a high refractive index inorganic layer having a refractive index higher than that of the low refractive index inorganic layer in a plurality of layers can be exemplified. Examples of the inorganic compound which can be used in the formation of the inorganic antireflection layer include oxides and fluorides such as silicon oxide (SiO₂), aluminum oxide (Al₂O₃), zirconium oxide (ZrO₂), titanium oxide (TiO₂), cerium oxide (CeO₂), hafnium oxide (HfO₂), and magnesium fluoride (MgF₂). The multilayered antireflection layer made from an inorganic compound is specifically one obtained by laminating a low refractive index layer made from a material such as SiO₂, SiOₓ, or MgF₂ and a high refractive index layer made from a material such as ZrO₂, Ta₂O₅, TiO₂, CeO₂, or Y₂O₃.

One example of the organic antireflection layer is one formed from a composition containing a component (1) and a component (2).
(1) an organosilicon compound represented by the general formula: R4iR5jSiX24-i-j
   In the formula, R⁴ represents an organic group having a polymerizable reactive group; R⁵ represents a hydrocarbon group having 1 to 6 carbon atoms; and X² represents a hydrolyzable group. At least either one of i and j is 1 and the other is 0 or 1.
(2) silica fine particles

R⁴ in the organosilicon compound as the component (1) for forming this organic antireflection layer is an organic group having a polymerizable reactive group, and examples thereof include a vinyl group, an allyl group, an acryl group, a methacryl group, an epoxy group, a mercapto group, a cyano group, and an amino group. R⁵ in the organosilicon compound as the component (1) is a hydrocarbon group having 1 to 6 carbon atoms, and examples thereof include a methyl group, an ethyl group, a butyl group, a vinyl group, and a phenyl group. X² in the organosilicon compound as the component (1) is a hydrolyzable functional group, and examples thereof include alkoxy groups such as a methoxy group, an ethoxy group, and a methoxyethoxy group; halogen groups such as a chloro group and a bromo group; and an acyloxy group.

Specific examples of the organosilicon compound as the component (1) include tetramethoxysilane, vinyltrialkoxysilane, vinyltrichlorosilane, vinyltri(β-methoxy-ethoxy)silane, allyltrialkoxysilane, acryloxypropyltrialkoxysilane, methacryloxypropyltrialkoxysilane, methacryloxypropyldialkoxymethylsilane, γ-glycidoxypropyltrialkoxysilane, β-(3,4-epoxycyclohexyl)-ethyltrialkoxysilane, mercaptopropyltrialkoxysilane, γ-aminopropyltrialkoxysilane, N-β(aminoethyl)-γ-aminopropylmethyldialkoxysilane, and tetraalkoxysilane.

A specific example of the silica fine particles as the component (2) for forming this organic antireflection layer is a silica sol obtained by dispersing silica fine particles with an average particle diameter of from 1 nm to 100 nm in, for example, water, an alcohol solvent, or another organic solvent in a colloidal state. Such silica fine particles preferably have a hollow interior. By using the silica fine particles having a hollow interior, the refractive index of the antireflection layer can be decreased, and a difference in the refractive index from the optical substrate or the layer (such as the hard coat layer) formed on the optical substrate is increased, and thereby the antireflection effect can be increased. By incorporating a gas or a solvent having a refractive index lower than that of silica in the hollow interior of the silica fine particles, the refractive index can be decreased as compared with silica fine particles with no hollow, and thus, the refractive index of the antireflection layer can be decreased.

The composition for forming the organic antireflection layer may contain, other than the components (1) and (2), any of a variety of resins such as polyurethane resins, epoxy resins, melamine resins, polyolefin resins, urethane acrylate resins, and epoxy acrylate resins; and any of a variety of monomers which can be used as raw materials for these resins such as methacrylates, acrylates, epoxy monomers, and vinyl monomers. As those having a function of decreasing the refractive index, a variety of fluorine-containing polymers and a variety of fluorine-containing monomers can be exemplified. Therefore, the composition for forming the antireflection layer may contain any of a variety of fluorine-containing polymers or any of a variety of fluorine-containing monomers. The fluorine-containing polymer is preferably a polymer obtained by polymerization of a fluorine-containing vinyl monomer, and more preferably has a functional group copolymerizable with another component.

Further, the composition for forming the organic antireflection layer may contain a solvent. That is, the composition for forming the organic antireflection layer can be used by diluting it with a solvent as needed for preparing an application liquid. Examples of the solvent include water, alcohols, esters, ketones, ethers, and aromatic solvents. Further, to the composition for forming the organic antireflection layer, a small amount of a curing catalyst, a surfactant, an antistatic agent, an ultraviolet absorber, an antioxidant, a light stabilizer such as hindered amine or hindered phenol, a disperse dye, an oil-soluble dye, a fluorescent dye, a pigment, or the like may be added as needed. By the addition of such a component, the applicability as a coating liquid can be improved or the performance of the layer after curing can be modified.

The antifouling layer typically has water and oil repellency. A composition for forming the antifouling layer preferably contains a fluorine-containing organosilicon compound (a fluorine-containing silane compound). More preferably, the composition for forming the antifouling layer may contain at least one compound of fluorine-containing organosilicon compounds represented by the following general formulae (3) to (6) (the formula (5) is a chemical formula). These fluorine-containing organosilicon compounds may be used alone or in admixture thereof.

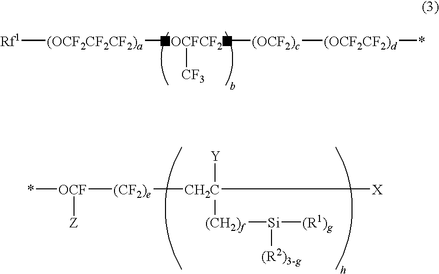

In the general formula (3), Rf¹ represents a perfluoroalkyl group; X represents hydrogen, bromine, or iodine; Y represents hydrogen or a lower alkyl group; Z represents fluorine or a trifluoromethyl group; R¹ represents a hydroxy group or a hydrolyzable group; R² represents hydrogen or a monovalent hydrocarbon group; a, b, c, d, and e each independently represent 0 or an integer of 1 or above, provided that a+b+c+d+e is not less than 1, and the order of the respective parenthesized repeating units represented by a, b, c, d, and e is not limited to that shown in the general formula (3); f represents 0, 1, or 2; g represents 1, 2, or 3; and h represents an integer of 1 or above.

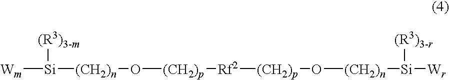

In the general formula (4), Rf² represents a divalent group containing a unit represented by the formula: —(CₖF₂ₖ)O—, (in the formula, k represents an integer of from 1 to 6) and having a linear perfluoropolyalkylene ether structure with no branch; R³ represents a monovalent hydrocarbon group having 1 to 8 carbon atoms; W represents a hydrolyzable group or halogen; p represents 0, 1, or 2; n represents an integer of from 1 to 5; and m and r each independently represent 2 or 3.

F₁₇C₈—C₂H₄—Si(NH)_{3/2} (5)

F₃C—(CF₂)ₛ—(CH₂)ₜ—Si(O—R)₃ (6)

In the general formula (6), R represents an alkyl group having 1 or more carbon atoms; s represents an integer of from 1 to 11; and t represents an integer of from 1 to 4.

Rf¹ in the general formula (3) is not particularly limited as long as it is a perfluoroalkyl group capable of forming an organic fluoropolymer, and examples thereof include a linear or branched perfluoroalkyl group having 1 to 16 carbon atoms, and preferred are CF₃—, C₂F₅—, and C₃F₇—.

When X in the general formula (3) is bromine or iodine, the radical reactivity of the fluorine-containing organosilicon compound represented by the general formula (3) is increased, therefore, it is advantageous to bind the compound to another compound through a chemical bond. Examples of Yin the general formula (3) include a methyl group, an ethyl group, a propyl group, and a butyl group. These groups may be linear or branched.

When R¹ in the general formula (3) is a hydrolyzable substituent, the hydrolyzable substituent is not particularly limited, and preferred examples thereof include halogen, —OR¹¹, —OCOR¹¹, —OC(R¹¹)═C(R¹²)₂, —ON═C(R¹¹)₂, and —ON═CR¹³. In the formulae, R¹¹ represents an aliphatic hydrocarbon group or an aromatic hydrocarbon group; R¹² represents hydrogen or an aliphatic hydrocarbon group having 1 to 4 carbon atoms; and R¹³ represents a divalent aliphatic hydrocarbon group having 3 to 6 carbon atoms. More preferably, R in the general formula (3) is chlorine, —OCH₃, or —OC₂H₅. R² in the general formula (3) represents hydrogen or a monovalent hydrocarbon group. The monovalent hydrocarbon group is not particularly limited, and preferred examples thereof include a methyl group, an ethyl group, a propyl group, and a butyl group. The monovalent hydrocarbon group may be linear or branched.

a, b, c, d, and e in the general formula (3) represent the number of repeating units in the perfluoropolyether chain constituting the main skeleton of the fluorine-containing organosilicon compound, and each independently represent 0 or an integer of 1 or above, and are not particularly limited as long as a+b+c+d+e is not less than 1. However, it is preferred that they are each independently from 0 to 200. If the molecular weight of the fluorine-containing organosilicon compound of the general formula (3) is considered, it is more preferred that a, b, c, d, and e are each independently from 0 to 50. a+b+c+d+e is preferably from 1 to 100. Further, the order of respective parenthesized repeating units represented by a, b, c, d and e is described in the stated order in the general formula (3), however, in view of the constitution of the ordinary perfluoropolyether chain, a binding order of these respective repeating units is not limited to the stated order.

f in the general formula (3) represents the number of carbon atoms of the alkylene group interposed between the carbon constituting the perfluoropolyether chain and the silicon binding thereto, and is 0, 1, or 2. g in the general formula (3) represents the number of the substituents R¹ bound to the silicon and is 1, 2 or 3. The substituent R² is bound to the silicon to which the substituent R¹ is not bound. h in the general formula (3) represents an integer of 1 or above and does not particularly have an upper limit, however, it is preferably an integer of from 1 to 10. The molecular weight of the fluorine-containing organosilicon compound represented by the general formula (3) is preferably from 5×10² to 1×10⁵. When it is less than 5×10², it is difficult to exhibit an antifouling effect, and when it exceeds 1×10⁵, the processability becomes poor. More preferably, it is from 1×10³ to 1×10⁴.

Rf² in the general formula (4) is a divalent group containing a unit represented by the formula: —(CₖF₂ₖ)O—, (in the formula, k represents an integer of from 1 to 6, preferably from 1 to 4) and having a linear perfluoropolyalkylene ether structure with no branch. Incidentally, when the respective p's in the general formula (4) is 0, a terminal of Rf² which is bound to oxygen (an oxygen atom) in the general formula (4) is not oxygen (an oxygen atom). Examples of Rf² in the general formula (4) include groups represented by the following general formulae, however, Rf² is not limited to those illustrated below.

—CF₂CF₂O(CF₂CF₂CF₂O)CF₂CF₂—

In the formula, v is an integer of 1 or above, preferably from 1 to 50, more preferably from 10 to 40.

—CF₂(OC₂F₄)_{v′}—(OCF₂)_{v″}—

In the formula, v′ and v″ are each independently an integer of 1 or above, preferably from 1 to 50, more preferably from 10 to 40, and the sum of v′ and v″ is an integer of from 10 to 100, preferably from 20 to 90, more preferably from 40 to 80. The arrangement of the repeating units of (OC₂F₄) and (OCF₂) in this formula is random.

R³ in the general formula (4) is a monovalent hydrocarbon group having 1 to 8, preferably 1 to 3 carbon atoms. Examples thereof include alkyl groups such as a methyl group, an ethyl group, a propyl group, a butyl group, a pentyl group, a hexyl group, a heptyl group, and an octyl group; cycloalkyl groups such as a cyclopentyl group and a cyclohexyl group; aryl groups such as a phenyl group, a tolyl group, and a xylyl group; aralkyl groups such as a benzyl group, and a phenethyl group; and alkenyl groups such as a vinyl group, an allyl group, a butenyl group, a pentenyl group, and a hexenyl group. Among these groups, a methyl group is preferred.

When W in the general formula (4) is a hydrolyzable group, examples thereof include alkoxy groups such as a methoxy group, an ethoxy group, a propoxy group, and a butoxy group; alkoxyalkoxy groups such as a methoxymethoxy group, a methoxyethoxy group, and an ethoxyethoxy group; alkenyloxy groups such as an allyloxy group and an isopropenoxy group; acyloxy groups such as an acetoxy group, a propionyloxy group, a butyl carbonyloxy group, and a benzoyloxy group; ketoxime groups such as a dimethyl ketoxime group, a methyl ethyl ketoxime group, a diethyl ketoxime group, a cyclopentanoxime group, and a cyclohexanoxime group; amino groups such as an N-methylamino group, an N-ethylamino group, an N-propylamino group, an N-butylamino group, an N,N-dimethylamino group, an N,N-diethylamino group, and an N-cyclohexylamino group; amide groups such as an N-methylacetamide group, an N-ethylacetamide group, and an N-methylbenzamide group; and aminoxy groups such as an N,N-dimethylaminoxy group and an N,N-diethylaminoxy group.

When W in the general formula (4) is halogen (a halogen atom), examples thereof include chlorine (a chlorine atom), bromine (a bromine atom), and iodine (an iodine atom). Among these, a methoxy group, an ethoxy group, an isopropenoxy group, and chlorine (a chlorine atom) are preferred as W.

p in the general formula (4) is an integer of from 0 to 2, and preferably 1. Further, n in the general formula (4) is an integer of from 1 to 5, and preferably 3. m and r in the general formula (4) are each independently 2 or 3, preferably 3 from the viewpoint of reactivity of hydrolysis and condensation, and film adhesiveness.

The molecular weight of perfluoropolyalkylene ether-modified silane (a hydrolytic condensation product of perfluoropolyalkylene ether-modified silane) represented by the general formula (4) is not particularly limited, however, a number average molecular weight thereof is preferably from 5×10² to 2×10⁴, more preferably from 1×10³ to 1×10⁴ from the viewpoint of stability, handleability, etc.

Examples of the fluorine-containing organosilicon compound represented by the general formula (6) include perfluoroalkyl alkylene alkoxysilane compounds such as CF₃(CF₂)₄CH₂CH₂Si (OC₂H₅)₃, CF₃(CF₂)₄CH₂CH₂SiCH₃(OC₂H₅)₂, CF₃(CF₂)₇CH₂CH₂Si (OC₂H₅)₃, CF₃CF₂CH₂CH₂Si (OC₃H₇)₃, CF₃(CF₂)₂CH₂CH₂Si (OC₃H₇)₃, CF₃(CF₂)₄CH₂CH₂SiCH₃(OC₃H₇)₂, CF₃(CF₂)₅CH₂CH₂SiCH₃(OC₃H₇)₂, and CF₃(CF₂)₇CH₂CH₂SiCH₃(OC₃H₇)₂.

The composition for forming the antifouling layer may contain a solvent. The solvent which can be incorporated in the composition is a solvent composed of a fluorine-containing organic compound and examples thereof include fluorine-modified aliphatic hydrocarbon solvents such as perfluoroheptane and perfluorooctane; fluorine-modified aromatic hydrocarbon solvents such as 1,3-di(trifluoromethyl)benzene and trifluoromethylbenzene; fluorine-modified ether solvents such as methyl perfluorobutyl ether and perfluoro(2-butyltetrahydrofuran); fluorine-modified alkylamine solvents such as perfluorotributylamine and perfluorotripentylamine; and petroleum benzine. As the solvents composed of a fluorine-containing organic compound, these solvents can be used alone or in combination of two or more of them. Among these solvents, fluorine-modified solvents are preferred from the viewpoint of solubility for the modified silane, wetting property of the surface to be applied, etc., and 1,3-di(trifluoromethyl)benzene, perfluoro(2-butyltetrahydrofuran), and perfluorotributylamine are particularly preferred.

In the composition for forming the antifouling layer, a catalyst can also be incorporated. Examples of the catalyst which can be incorporated therein include catalysts called curing catalysts to be used for acceleration of curing. Specifically, as the catalyst which can be incorporated in the composition for forming the antifouling layer, a transesterification catalyst can be used. As a specific example of the transesterification catalyst, at least one compound selected from titanium compounds, tin compounds, lead compounds, zirconium compounds, molybdenum compounds, and ytterbium compounds can be exemplified.

Examples of the titanium compound that functions as the catalyst include TiX₃¹, Ti(OAc)₃, Ti(OMe)₃, Ti(OEt)₃, Ti(OBu)₃, Ti(OPh)₃, TiX₄¹, Ti(OAc)₄, Ti(OMe)₄, Ti(OEt)₄, Ti(OBu)₄, and Ti (OPh)₄, wherein Ac represents an acetyl group, Me represents a methyl group, Et represents an ethyl group, Bu represents a butyl group, Ph represents a phenyl group, and X¹ represents halogen (a halogen atom).

Examples of the tin compound that functions as the catalyst include acetoxy complexes of tin such as Ph₄Sn, Sn(OAc)₄, Bu₂Sn(OAc)₂, Me₃SnOAc, Et₃SnOAc, Bu₃SnOAc, and Ph₃SnOAc; alkoxy or aryloxy complexes of tin such as Sn(OMe)₄, Sn(OEt)₄, Sn(OPh)₄, Bu₂Sn(OMe)₂, Ph₂Sn(OMe)₂, Bu₂Sn(OEt)₂, Ph₂Sn(OPh)₂, Et₃SnOMe, and Ph₃SnOMe; Me₃Sn(OCOPh); Bu₂SnO; BuSnO(OH); Et₃SnOH; Ph₃SnOH; and Bu₂SnCl₂, wherein Ac represents an acetyl group, Me represents a methyl group, Et represents an ethyl group, Bu represents a butyl group, and Ph represents a phenyl group.

A method for forming the antifouling layer may be a dry method such as vapor deposition or a wet method such as dip coating or spin coating. In the case of a wet method, for removing a solvent, heating may be performed before the acid treatment.

### Example 1

As an optical substrate, a plastic spectacle lens (manufactured by Seiko Epson Corporation, trade name: Super Sovereign (SSV)) having a refractive index of 1.67 was prepared, and a primer layer was formed on a surface of this substrate, and a hard coat layer was formed on a surface of this primer layer.

### 1. Formation of Organic Antireflection Layer

To 47.8 parts by weight (0.08 mol) of a fluorine-containing silane compound represented by the chemical formula: (CH₃O)₃Si—C₂H₄—C₆F₁₂—C₂H₄—Si(OCH₃)₃, 312.4 parts by weight of methanol as an organic solvent, 4.7 parts by weight (0.02 mol) of γ-glycidoxypropyltrimethoxysilane as a non-fluorine-containing silane compound were added, and further 36 parts by weight of a 0.1 N aqueous solution of hydrochloric acid was added and all components were mixed. Thereafter, the resulting mixture was stirred in a thermostat bath whose temperature was set to 25° C. for 2 hours, whereby a silicone resin with a solid content of 10 wt % was obtained as the above-mentioned component (1).

To the thus obtained silicone resin, a hollow silica-isopropanol dispersion sol (manufactured by Catalysts & Chemicals Industries Co., Ltd., solid content: 20 wt %, average particle diameter: 35 nm, shell thickness: 8 nm) was added as silica fine particles having a hollow interior being the above-mentioned component (2) such that the solid content ratio of the silicone resin to the hollow silica was 70:30. Further, 935 parts by weight of propylene glycol monomethyl ether was added thereto as a dispersion medium to dilute the mixture, whereby a composition with a solid content of 3 wt % was obtained.

To this composition, acetylacetone aluminum (Al(acac)₃) was added as a metal complex salt having aluminum (Al(III)) as a central metal such that the solid content thereof to the final composition (a coating composition for forming an organic antireflection layer) was 3 wt %, and then, the resulting mixture was stirred for 4 hours. By this procedure, an antireflection treatment liquid was obtained as the coating composition for forming an organic antireflection layer.

The above-prepared spectacle lens having the primer layer and the hard coat layer was subjected to a plasma treatment by air plasma. Thereafter, the thus obtained antireflection treatment liquid was applied to the surface of the hard coat layer such that a dried film thickness was 100 nm by a spinner method. Then, the spectacle lens was put in a thermostat bath whose temperature was maintained at 125° C. for 2 hours to cure the applied antireflection treatment liquid. By this procedure, a spectacle lens having the primer layer, the hard coat layer, and the organic antireflection layer was obtained.

### 2. Formation of Antifouling Layer

“KY-130” (trade name, manufactured by Shin-Etsu Chemical Co., Ltd.) was prepared as a fluorine-containing silane compound A (a fluorine-containing silane compound having a high molecular weight, i.e., a molecular weight ranging from 1000 to 10000), and also “KP-801M” (trade name, manufactured by Shin-Etsu Chemical Co., Ltd.) was prepared as a fluorine-containing silane compound B (a fluorine-containing silane compound having a low molecular weight, i.e., a molecular weight ranging from 100 to 700). “KY-130” contains a fluorine-containing organosilicon compound represented by the above-mentioned general formula (4). The fluorine-containing silane compound A and the fluorine-containing silane compound B were mixed such that the solid content ratio by weight was 80:20. The resulting mixture was impregnated into a porous ceramic pellet and a matter whose solid content weight after drying was 30 mg was prepared as a vapor deposition source.

The spectacle lens having the primer layer, the hard coat layer, and the organic antireflection layer was placed in a vacuum deposition device, and air was discharged such that the pressure was 2×10⁻² Pa. Thereafter, the above-prepared vapor deposition source was heated to 600° C. and vapor deposition was performed. The heating of the vapor deposition source was performed using a halogen lamp. The heating of the vapor deposition source may be performed using another method such as an electron gun or a resistive heater. The vapor deposition time was set to 3 minutes. After completion of the vapor deposition, the spectacle lens was taken out of the vacuum deposition device, and then reversed and placed therein again, and vapor deposition was performed in the same manner. Thereafter, the spectacle lens was taken out of the vacuum deposition device. By this procedure, the antifouling layer (water and oil repellent film) was formed on both surfaces of the spectacle lens. That is, by this procedure, a spectacle lens (work) having the primer layer, the hard coat layer, the organic antireflection layer and the antifouling layer was prepared.

3. Hydrochloric acid treatment and rinsing treatment

The thus prepared work was dipped in a 1 N aqueous solution of hydrochloric acid (acid treatment). The dipping time t was set to 1 minute. After dipping, the work subjected to the acid treatment was rinsed with pure water to sufficiently remove hydrochloric acid (rinsing), and then dried.

### 4. Annealing Treatment

The rinsed work was placed in a thermo-hygrostat bath whose temperature and relative humidity were set to 90° C. and 60%, respectively, and maintained therein for 2 hours (annealing). By this procedure, an optical article (spectacle lens) was prepared.

### Example 2

By using the work prepared in Example 1-1 and 1-2, the treatments described in Example 1-3 and 1-4 were performed, provided that the dipping time t in the acid treatment using hydrochloric acid was set to 5 minutes.

### Example 3

By using the work prepared in Example 1-1 and 1-2, the treatments described in Example 1-3 and 1-4 were performed, provided that the dipping time t in the acid treatment using hydrochloric acid was set to 10 minutes.

### Example 4

By using the work prepared in Example 1-1 and 1-2, the treatments described in Example 1-3 and 1-4 were performed, provided that the dipping time t in the acid treatment using hydrochloric acid was set to 60 minutes.

### Example 5

By using the work prepared in Example 1-1 and 1-2, the treatments described in Example 1-3 and 1-4 were performed, provided that in the acid treatment, 0.5 N hydrochloric acid was used and the dipping time t was set to 60 minutes.

### Example 6

By using the work prepared in Example 1-1 and 1-2, the treatments described in Example 1-3 and 1-4 were performed, provided that in the acid treatment, 2 N hydrochloric acid was used and the dipping time t was set to 5 minutes.

### Example 7

By using the work prepared in Example 1-1 and 1-2, the treatments described in Example 1-3 and 1-4 were performed, provided that in the acid treatment, 1 N sulfuric acid was used and the dipping time t was set to 10 minutes.

### Example 8

A work was prepared in the same manner as in Example 1 except that after obtaining a spectacle lens having an organic antireflection layer formed in the (formation of organic antireflection layer) described in Example 1-1, “Optool DSX” (trade name, manufactured by Daikin Chemical Industries, Ltd.) was used as the fluorine-containing silane compound A (a fluorine-containing silane compound having a high molecular weight, i.e., a molecular weight ranging from 1000 to 10000) in the (formation of antifouling layer) described in Example 1-2. Then, by using this work, the treatments described in Example 1-3 and 1-4 were performed in the same manner as in Example 1, provided that in the acid treatment, 1 N hydrochloric acid was used and the dipping time t was set to 10 minutes.

### Comparative Example 1

By using the work prepared in Example 1-1 and 1-2, the treatment described in Example 1-4 was performed. That is, the acid treatment using hydrochloric acid described in Example 1-3 was not performed.

### Comparative Example 2

After obtaining a spectacle lens having an organic antireflection layer formed in the (formation of organic antireflection layer) described in Example 1-1, further 1 wt % hydrochloric acid was added to a treatment liquid obtained by mixing the fluorine-containing silane compound A and the fluorine-containing silane compound B at the same ratio as in Example 1 in the (formation of antifouling layer) described in Example 1-2 and the resulting treatment liquid was stirred for 10 minutes. Thereafter, the treatment liquid was impregnated into a pellet, and an antifouling layer was formed in the same manner as in Example 1. By using the thus prepared work, the (annealing treatment) described in Example 1-4 was performed. That is, the (acid treatment) described in Example 1-3 was not performed.

### Comparative Example 3

A work was prepared in the same manner as in Comparative example 2, provided that after adding 1 wt % hydrochloric acid to the treatment liquid of the fluorine-containing silane compounds A and B and stirring the resulting treatment liquid for 60 minutes, and the treatment liquid was impregnated into a pellet and applied to an organic antireflection layer, whereby an antifouling layer was formed.

### Evaluation

A steel wool rubbing test was performed for the optical articles (spectacle lenses) obtained in Examples 1 to 8 and Comparative examples 1 to 3. Steel wool #0000 was impressed on a surface of each optical article under a load of 200 g, and reciprocated 500 times. The degree of scratches generated at this time was observed through reflection. Further, after placing each optical article in a xenon (Xe) weather meter for 100 hours, a test was performed by the same procedure as described above. These results were evaluated and assigned any of the following 6 levels consisting of level 0 to level 5. Here, a scratched area ratio refers to a ratio of an area where scratches were generated to the rubbed area.
Level 5: A scratched area ratio is less than 10%.
Level 4: A scratched area ratio is 10% or more and less than 20%.
Level 3: A scratched area ratio is 20% or more and less than 30%.
Level 2: A scratched area ratio is 30% or more and less than 40%.
Level 1: A scratched area ratio is 40% or more and less than 50%.
Level 0: A scratched area ratio is 50% or more.

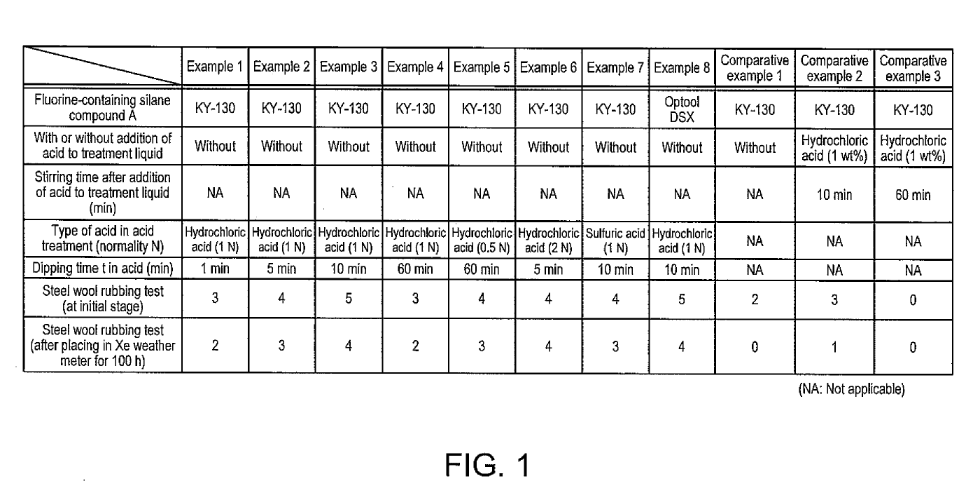

FIG. 1 is a table summarizing the results of steel wool rubbing test for optical articles (spectacle lenses) obtained in Examples 1 to 8 and Comparative examples 1 to 3.

The spectacle lens obtained in Comparative example 1 (without acid treatment) showed level 2 in the rubbing test at an initial stage and showed level 0 in the rubbing test after placing it in the xenon weather meter for 100 hours.

The spectacle lens obtained in Example 1 (dipping time t: 1 min (in acid treatment)) showed level 3 in the rubbing test at an initial stage and showed level 2 in the rubbing test after placing it in the xenon weather meter for 100 hours. As compared with Comparative examples 1 and 3, it is found that the durability of the spectacle lens obtained in Example 1 at an initial stage and after placing it in the xenon weather meter for 100 hours was improved. Further, as compared with Comparative example 2, it is found that the durability thereof at an initial stage showed an equivalent result, however, the durability thereof after placing it in the xenon weather meter for 100 hours was improved.

The spectacle lens obtained in Example 2 (dipping time t: 5 min) showed level 4 in the rubbing test at an initial stage and showed level 3 in the rubbing test after placing it in the xenon weather meter for 100 hours. As compared with Comparative examples 1 to 3, it is found that the durability of the spectacle lens obtained in Example 2 at an initial stage and after placing it in the xenon weather meter for 100 hours was improved. Further, even as compared with Example 1, it is found that the durability thereof at an initial stage and after placing it in the xenon weather meter for 100 hours was improved.

The spectacle lens obtained in Example 3 (dipping time t: 10 min) showed level 5 in the rubbing test at an initial stage and showed level 4 in the rubbing test after placing it in the xenon weather meter for 100 hours. As compared with Comparative examples 1 to 3, it is found that the durability of the spectacle lens obtained in Example 3 at an initial stage and after placing it in the xenon weather meter for 100 hours was improved. Further, even as compared with the other Examples, it is found that the durability thereof at an initial stage and after placing it in the xenon weather meter for 100 hours was improved. In this embodiment, the durability of the spectacle lens obtained in Example 3 (dipping time t: 10 min (in acid treatment)) is the highest.

The spectacle lens obtained in Example 4 (dipping time t: 60 min) showed level 3 in the rubbing test at an initial stage and showed level 2 in the rubbing test after placing it in the xenon weather meter for 100 hours. As compared with Comparative examples 1 and 3, it is found that the durability of the spectacle lens obtained in Example 4 at an initial stage and after placing it in the xenon weather meter for 100 hours was improved. Further, as compared with Comparative example 2, it is found that the durability thereof at an initial stage showed an equivalent result, however, the durability thereof after placing it in the xenon weather meter for 100 hours was improved. As compared with Examples 2 and 3, it is found that the durability thereof is somewhat lower, however, it can be intended to improve the durability to the same degree as in the case of Example 1.

In Examples 5 to 8, the experiment was repeated by changing the normality N and type of the acidic liquid to be used in the acid treatment and further the fluorine-containing silane compound to be used in the formation of the antifouling layer. Even from these results, it was found that the durability of these spectacle lenses at an initial stage and after placing it in the xenon weather meter for 100 hours was improved by performing the acid treatment as compared with Comparative examples 1 to 3 in which the acid treatment was not performed. The spectacle lens obtained in Comparative example 2 in which hydrochloric acid was added to the treatment liquid for forming the antifouling layer showed level 3 in the rubbing test at an initial stage and showed level 1 in the rubbing test after placing it in the xenon weather meter for 100 hours. As compared with Comparative example 1, the durability of the spectacle lens obtained in Comparative example 2 at an initial stage and after placing it in the xenon weather meter for 100 hours was improved, however, the durability thereof after placing it in the xenon weather meter for 100 hours was significantly decreased as compared with the samples (works) of Examples in which the acid treatment was performed.

Similarly, the spectacle lens obtained in Comparative example 3 in which hydrochloric acid was added to the treatment liquid for forming the antifouling layer showed level 0 in the rubbing test at an initial stage and after placing it in the xenon weather meter for 100 hours and was found to have low durability.

It is considered that the results of Comparative examples 2 and 3 show that it is difficult to control condensation by the method of adding an acid such as hydrochloric acid to the treatment liquid for forming the antifouling layer. That is, it was shown that when an acid is added to the treatment liquid, there is a possibility that condensation in the treatment liquid is accelerated and the durability of the spectacle lens at an initial stage is improved, however, condensation with a substrate surface (for example, an antireflection layer) is little affected, and the long-term durability cannot be improved. Further, from the results of Comparative example 3, it was shown that in the case where the method of adding an acid such as hydrochloric acid to the treatment liquid before forming the antifouling layer is employed, when the treatment liquid is stored for a long period of time exceeding a certain limit after the addition of hydrochloric acid, condensation in the treatment liquid proceeds too much and the reaction with the substrate may be inhibited in some cases.

From these Examples and Comparative examples, it is found that a spectacle lens with improved durability can be produced by performing the acid treatment. Further, for obtaining a spectacle lens with improved durability, if the acid treatment of dipping the spectacle lens in a 1 N aqueous solution of hydrochloric acid is performed, the dipping time is preferably from 1 to 60 minutes. For obtaining a spectacle lens with further improved durability, the dipping time in the acid treatment is preferably from 5 to 15 minutes.

On the other hand, in was shown that in the case where the spectacle lens is dipped in hydrochloric acid, the degree of condensation can be easily controlled by adjusting the dipping time. Further, the antifouling layer and the organic antireflection layer can be activated simultaneously, and the reaction in the interface between the antifouling layer and the antireflection layer is also accelerated. Therefore, not only the durability at an initial stage, but also the durability after a lapse of long time can be improved.

As another method for activating the antireflection layer, a plasma treatment and the like are conceivable. However, in the case of an organic antireflection layer, the material is an organic substance, therefore, when a physical activation method such as a plasma treatment is employed, the damage is bigger than the expected activation and the long-term durability may be decreased instead. On the other hand, by dipping the work in the above-mentioned acid treatment, also the long-term durability can be improved, and it was found that by the acid treatment in the invention, the activation can be achieved without damaging the interface between the antifouling layer and the antireflection layer and the long-term durability can be improved.

Further, in the respective Examples described above, the effect could be confirmed not only by changing the dipping time, but also changing the concentration of hydrochloric acid or the type of acid. There is a correlation in terms of effect between the concentration of hydrochloric acid and the dipping time. That is, at a low concentration of hydrochloric acid, the effect can be obtained when the dipping time is long, and at a high concentration of hydrochloric acid, the effect can be obtained when the dipping time is short. Further, from Example 7, the effect could be confirmed even with sulfuric acid. Although sulfuric acid is a divalent acid, when the hydrogen concentration is adjusted to a value equal to the case of using hydrochloric acid, a similar effect can be obtained. In fact, the acid concentration and the dipping time may appropriately be set by considering the acid valency (normality) and the degree of ionization of acid.

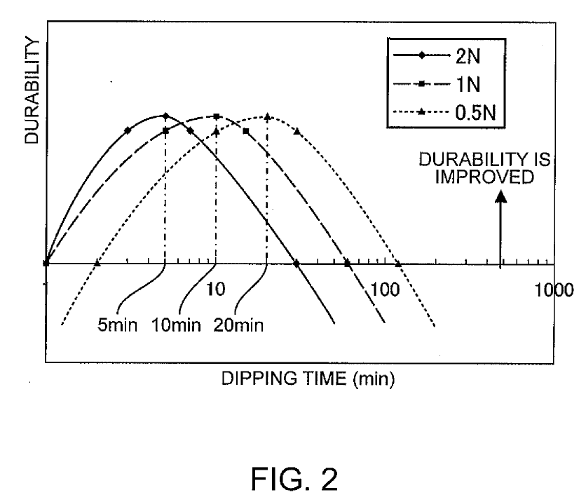

FIG. 2 is a graph schematically showing a relationship between the dipping time t in the acid treatment and durability of the optical article. When the acid treatment is performed, a bond such as —Si—O—Si— (a siloxane bond) or —Si—O—C— in the molecules forming the surface of the antireflection layer and the antifouling layer is cleaved. Therefore, until the dipping time t in the acid treatment reaches a certain time, the reaction with the antireflection layer is accelerated and the antifouling layer is favorably fixed on the surface of the antireflection layer, and also the reaction between molecules forming the antifouling layer is accelerated, and the antifouling layer is favorably formed. Therefore, the durability of the optical article is improved in an ever-increasing manner. However, when the dipping time t in the acid treatment is further prolonged, the durability of the optical article is gradually decreased. The reason is presumably that in the antireflection layer, the acid dominantly cleaves the bond of molecules forming the antireflection layer or the bond formed between the antireflection layer and the antifouling layer or the bond between molecules in the antifouling layer.

FIG. 2 is a graph schematically showing a case where the acid concentration (normality) is set to several values and the dipping time t is changed. As shown in the above Examples, a similar tendency is observed also in the case where the dipping time t is fixed and the acid concentration is changed. Further, it is considered that a similar tendency is observed also in the case where the acid treatment is performed using an acid other than hydrochloric acid such as acetic acid, sulfuric acid, or hydrofluoric acid. The case where the acid treatment is performed using sulfuric acid is shown in the above Example. It is considered that the durability of the optical article is improved in an ever-increasing manner until the acid concentration reaches a certain value. However, when the acid concentration is further increased, the durability of the optical article is considered to be gradually decreased. By performing the acid treatment at an appropriate acid concentration for an appropriate acid treatment time, it can be intended to improve the durability of the optical article (durability of the antifouling layer).

From these results, an optimal dipping time t is inversely proportional to the normality and the degree of ionization of an acid to be used in the acid treatment and can be defined by the following equation (A).

t=k/(N·α) (A)

In the equation, N represents an acid normality; k represents a constant; and α represents the degree of ionization.

In the case where the acid to be used in the acid treatment is a strong acid such as hydrochloric acid, sulfuric acid, or nitric acid, when the acid concentration is about 1 to 2 N, or lower, the degree of ionization α is about 1. On the other hand, in the case where a weak acid such as acetic acid, formic acid, carbonic acid, sulfurous acid, hypochlorous acid, or oxalic acid is used, when, similarly, the acid concentration is about 1 to 2 N, or lower, the degree of ionization α is between about 0.1 and about 0.01. As a specific example, the degree of ionization (a) of acetic acid is 0.013. When the unit of the dipping time t is minute, the constant k is preferably from 1 to 60, more preferably from 5 to 15, further more preferably 10. For example, in the case where a strong acid such as hydrochloric acid having a degree of ionization α of 1 is used in the acidic liquid in the acid treatment, when the normality of the acidic liquid is 0.5 N, a preferred dipping time t is from 2 to 120 min, and a more preferred dipping time t is from 10 to 30 min. Further, when the normality of the acidic liquid is 1 N, a preferred dipping time t is from 1 to 60 min, a more preferred dipping time t is from 5 to 15 min, and a most preferred dipping time t is 10 min. Further, when the normality of the acidic liquid is 2 N, a preferred dipping time t is from 1 to 30 min, a more preferred dipping time t is from 3 to 8 min, and a most preferred dipping time t is 5 min.

The optical article to which the production process of the invention can be applied is not limited to lenses for spectacles and includes, for example, lenses for other optical apparatuses, display panels such as liquid crystal display panels, optical recording media such as DVD, and other articles through which light is transmitted or from which light is reflected.

The entire disclosure of Japanese Patent Application Nos: 2008-67210, filed Mar. 17, 2008 and 2008-318003, filed Dec. 15, 2008 are expressly incorporated by reference herein.

What is claimed is:

1. A process for producing an optical article comprising:
subjecting a work in which an antireflection layer is formed on an optical substrate directly or via another layer interposed therebetween and an antifouling layer is formed on a surface of the antireflection layer to an acid treatment by dipping it in an acidic liquid;
rinsing the work subjected to the acid treatment; and
annealing the rinsed work.

2. The process for producing an optical article according to claim 1, wherein a time t for dipping the work in the acidic liquid in the acid treatment is defined by the following equation:
t=k/(N·α)
wherein N represents a normality; k represents a constant; and α represents a degree of ionization.

3. The process for producing an optical article according to claim 1, wherein the acidic liquid contains any of hydrochloric acid, acetic acid, sulfuric acid, hydrofluoric acid, nitric acid, formic acid, carbonic acid, sulfurous acid, hypochlorous acid, and oxalic acid.

4. The process for producing an optical article according to claim 1, wherein the acidic liquid contains hydrochloric acid.

5. The process for producing an optical article according to claim 4, wherein the acidic liquid is a 1 N aqueous solution of hydrochloric acid and the dipping time in the acid treatment is from 1 to 60 minutes.

6. The process for producing an optical article according to claim 5, wherein the dipping time in the acid treatment is from 5 to 15 minutes.

7. The process for producing an optical article according to claim 1, wherein the antireflection layer is an organic antireflection layer.
